(19) United States
(12) Patent Application Publication
(10) Pub. No.: US 2022/0284413 A1
(43) Pub. Date: Sep. 8, 2022

(54) SYSTEM AND METHOD FOR ELECTRONIC-COMMERCE TRANSACTIONS BETWEEN INDIVIDUALS IN INSTALLMENTS

(71) Applicant: Amer Huzaym Alruwaili, Dammam (SA)

(72) Inventor: Amer Huzaym Alruwaili, Dammam (SA)

(21) Appl. No.: 17/653,548

(22) Filed: Mar. 4, 2022

Related U.S. Application Data
(60) Provisional application No. 63/200,420, filed on Mar. 5, 2021.

(51) Int. Cl. G06Q 20/24

(52) U.S. Cl. CPC G06Q 20/24

(57) ABSTRACT

A method for electronic commerce transactions on a system including at least one computer device and a server. A first user accesses a graphical user interface a computer device. The user logs into the system and selects a second user. The first user may then define a payment amount, a payment schedule, and a payment source. A sale transactions occurs between the first and second user in installments paid over the payment schedule.

### CROSS-REFERENCE TO RELATED APPLICATION

This application claims the benefit of priority of U.S. provisional application No. 63/200,420, filed Mar. 5, 2021, the contents of which are herein incorporated by reference.

### BACKGROUND OF THE INVENTION

Electronic commerce (e-commerce) platforms for use in effecting sales and trade between individuals include eBay™ and PayPal™ Existing e-commerce platforms do not offer expanded payment options for purchasers such as the ability to pay in installments or other utilities to simplify trade and payments.

Current available options use credit cards or debit cards such as VISA™ cards. Some available options even allow the use of cryptocurrency. However, if a purchaser lacks enough funds, the purchaser is required to take out a loan for the purchase, typically from a third party. This loan carries interest which must be repaid over time. The interest rate of the loan is determined by the third party using various factors such as the purchaser's credit score, credit history, or income. No options allow the purchaser to simply pay in installments at 0% interest or at an interest rate agreed upon by the purchaser and the seller.

As can be seen, there is a need for a system and method for e-commerce transactions between individuals which enables payment in installments as an alternative option to payment in full.

### SUMMARY OF THE INVENTION

In one aspect of the present invention, a method for electronic commerce transactions comprises providing a system including at least one computer device and a server wherein a system enables a first user to access a graphical user interface on a computer device, log into the system, select a second user in the system, define a payment amount, define a payment schedule, and define a payment source. The system conducts a sale transaction in the system between the first user and the second user in installments paid over the payment schedule from the payment source.

These and other features, aspects and advantages of the present invention will become better understood with reference to the following drawings, description, and claims.

### BRIEF DESCRIPTION OF THE DRAWINGS

FIG. 1 is a schematic diagram of an e-commerce system according to an embodiment of the present invention;

FIG. 2 is a view of a graphical user interface for use with a transaction method according to an embodiment of the present invention;

FIG. 3 is a flow chart thereof, showing steps which may be performed through the graphical user interface; and

FIG. 4 is a flow chart showing steps of a transaction method according to an embodiment of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims with reference to the drawings.

A general overview of the various features of the invention will be provided, with a detailed description following. Broadly, an embodiment of the present invention provides a system and method for electronic commerce (e-commerce) transactions which enables an installment payment option.

The system may include at least one computer with a user interface. The computer may include at least one processing unit coupled to a form of memory. The computer may include, but is not limited to, a microprocessor, a server, a desktop, laptop, and smart device, such as, a tablet and smart phone, and combinations thereof. The computer may include a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud or the like.

The ordered combination of various ad hoc and automated tasks in the presently disclosed platform necessarily achieves technological improvements through the specific processes described more in detail below. In addition, the unconventional and unique aspects of these specific automation processes represent a sharp contrast to merely providing a well-known or routine environment for performing a manual or mental task.

In an embodiment of the present invention, the system and method of the present invention offer users the ability to define payment terms, schedule multiple payments, schedule amount and timing of payments, select payment source, provide debit options, and make payments in installments instead of payment in full. It is understood that payment in full remains an option but not the sole option.

The system and method of the present invention simplifies trade by enabling users to engage in simplified trade transactions by debit installments.

In some embodiments of the present invention, the present invention provides a system including a mobile computing device, a software application, and a system website. The mobile computing device may be any suitable device, such as, for example without limitation, a smart phone or a tablet. The software application may be provided as a downloadable software application, a commercially available mobile software application product for purchase and loading onto the mobile computing device, or in a form of software as a service. The system website may include user modules accessible by the computing device for use by the user to operate the system.

The system may operate or may function in the following manner. The present invention provides a website and a mobile application to help a user conduct sale and purchase transactions in installments over an extended period of time. The system may be used to conduct transactions between two or more individual users and may be used to undertake transactions involving more than two users. The system may also be used to conduct transactions between a business and an individual, or transactions between businesses (business to business, or B2B) for sale or purchase of any goods and services. Transactions may be structured as daily, weekly, monthly, or yearly installments according to terms, payment schedules, and payment amounts as agreed upon by users who are transacting parties.

The system may be capable of providing end to end support of the entire user process and system process, to assist users in purchase and sale of goods or services using a debit system. Payments do not have to be in full and may be provided in installments and according to any agreed upon schedule.

In some embodiments of the present invention, a method including one or more of the following steps and combinations thereof may be provided. In some embodiments, the method steps may be followed in an order different than is listed. A system may be provided. At least one user may access and install a system mobile computer software application on a mobile device, or any computer or computing device. At least one user may access the system by the mobile device (or any computer) in any suitable way, such as, for example without limitation, from a mobile application or other installed software, or by visiting a system website. The at least one user may log into the system. After logging into the system, the at least one user may use the website and mobile applications to assist the at least one user in conducting sale and/or purchase transactions in installments over an extended period of time. The system may be used to conduct transactions between the at least one user and at least one additional user. The at least one user may include two or more individual users. The at least one user may comprise a first user and a second user and the system may be used to effect one or more transactions between the first user and the second user.

In some embodiments, the system may be used to effect transactions involving more than two users. In some embodiments, the at least one user may comprise a first user that is a business user, and a second user that is an individual user. In some embodiments, the at least one user may comprise a first user that is a business user and a second user that is a business user. In some embodiments, the transaction may be any legal transaction for the sale or purchase of any legal goods or services. A report may be generated of the transaction.

The computer-based data processing system and method described above is for purposes of example only and may be implemented in any type of computer system or programming or processing environment, or in a computer program, alone or in conjunction with a dedicated hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run from a server computer system that can be accessed by a plurality of client computer systems interconnected over an intranet network or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

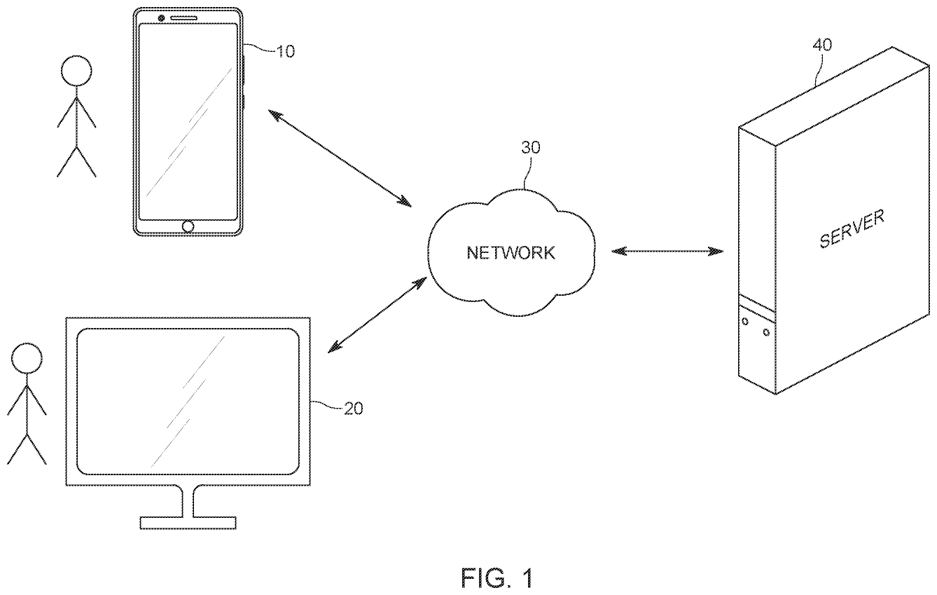

Referring now to the Figures, FIG. 1 shows a computer network through which the present invention may be implemented. The present invention includes a cellular device 10 and a personal computer 20 interconnected through a network 30.

The network 30 may be coupled to or manage by a server 40. The present invention is not limited to the cellular device 10 and the personal computer 20 shown in FIG. 1. Instead, the cellular device 10 and the personal computer 20 are illustrated as an example of the network 30 connecting various computer devices 10, 20 to a server 40. The cellular device 10 and/or the personal computer 20 may access the server 40 via the network 30.

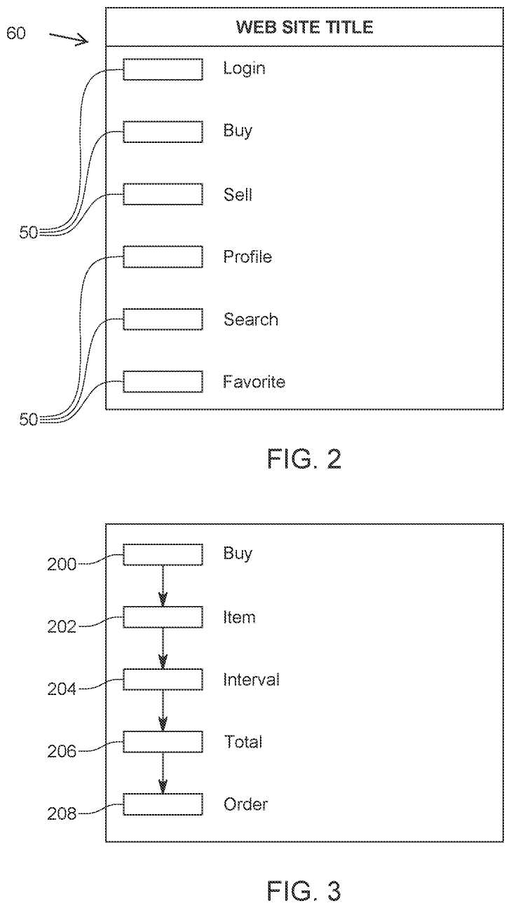

FIG. 2 shows a graphical user interface 60 displayed by a website according to an embodiment of the present invention. Various options 50 are shown on the graphical user interface 60. The options 50 demonstrate various functionalities of the interface 60 accessible by a user in performance of the inventive method.

FIG. 3 details steps which may be performed through the graphical user interface 60. A user may list or select a purchase at a Buy step 200. The user may then describe the item in an Item step 202. This step may include detailing a total cost and an interest rate if an interest rate is chosen. The user may then select an interval for payments and a total length of time until payment completion at an Interval step 204. At a Total step 206, the user may confirm selections previously made. At an Order step 208, the user may submit an order to another user who may confirm the order. Upon confirmation, this would implement the selections made in the above steps. The order in which these steps are performed is not particularly limited by the present invention.

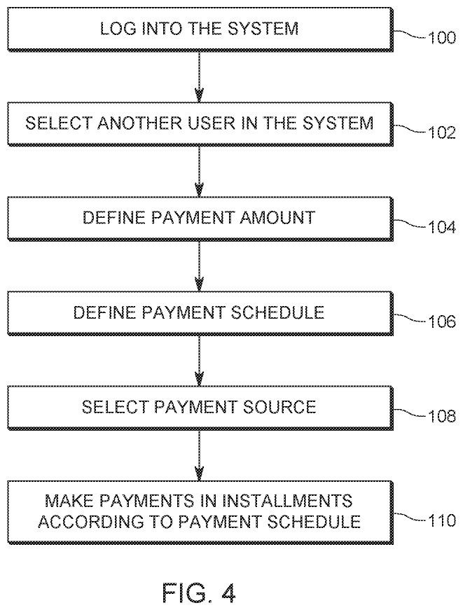

FIG. 4 shows steps of an e-commerce transaction method according to an embodiment of the present invention. A first user may log into a system 100. The first user may then select a second user in the system 102. The first user may then define a payment amount 104. The first user may then define a payment schedule 106. The first user may then select a payment source 108. The first user may then make payments to the second user in installments 110 according to the payment schedule defined in step 106. Alternatively, the second user may select the payment source 108 and make payments to the first user 110 according to the payment schedule 106.

It should be understood, of course, that the foregoing relates to exemplary embodiments of the invention and that modifications may be made without departing from the spirit and scope of the invention as set forth in the following claims.

What is claimed is:

1. A method for electronic commerce transactions comprising:
providing a system including at least one computer device and a server, wherein the system enables a first user to perform the following steps:
accessing a graphical user interface on a computer device;
logging into the system;
selecting a second user in the system;
defining a payment amount;
defining a payment schedule; and
defining a payment source; and
conducting a sale transaction implemented by the system between the first user and the second user in installments paid over the payment schedule from the payment source.

2. An e-commerce system for installment payment transactions, comprising a processor and a memory operative to implement the method of claim 1.
